(19) United States
(12) Patent Application Publication
(10) Pub. No.: US 2017/0308934 A1
(43) Pub. Date: Oct. 26, 2017

(54) MANAGEMENT METHOD OF POWER ENGINEERING COST

(71) Applicants: Economy Research Institute of State Grid Zhejiang Electric Power, Hangzhou Zhejiang (CN); State Grid Corporation of China, Beijing (CN); Hangzhou Yihe Electric Power Technology Information Co., LTD., Hangzhou (CN)

(72) Inventors: Weidong LIU, Hangzhou Zhejiang (CN); Min YU, Hangzhou Zhejiang (CN); Liang LINAG, Hangzhou Zhejiang (CN); Jun TONG, Hangzhou Zhejiang (CN); Fuyan LIU, Hangzhou Zhejiang (CN); Zhanghua CAI, Hangzhou Zhejiang (CN); Jia CHEN, Hangzhou Zhejiang (CN); Hui CHEN, Hangzhou Zhejiang (CN)

(21) Appl. No.: 15/491,187

(22) Filed: Apr. 19, 2017

(30) Foreign Application Priority Data
Apr. 22, 2016 (CN) 201610260249.5

(51) Int. Cl. G06Q 30/02; G06Q 40/06; G06Q 50/06

(52) U.S. Cl. CPC G06Q 30/0283; G06Q 50/06; G06Q 30/0201; G06Q 40/06

(57) ABSTRACT

The present invention discloses a management method of power engineering cost, including: 1) collect and collate the historical power engineering data, and establish engineering sample database; 2) Explore the factors influencing power engineering cost and construct the cost factor associated topology; 3) identify the price transmission path; 4) Establish the power engineering cost change trend model based on the factor distribution on the price transmission path, and conduct training on the model combined with the historical data, to solve the set of cost change trend of the equipments and materials required in the current stage of engineering. By considering the effect of market price fluctuation on the price transmission of required equipments and materials, this invention can propose appropriate management control program for the next stage of engineering costs more clearly, further shrink the deviation of cost, reduce the investment risk of power engineering and improve the dynamic control system of power engineering.

### FIELD OF THE INVENTION

The present invention relates to a field of engineering cost management, in particular, to a management method of power engineering cost.

### BACKGROUND

With the rapid development of China's national economy, the electricity demands grow rapidly. In order to meet the social demand for electricity, the power construction investment is also growing. The engineering cost of power construction projects is related to the economic benefits and long-term development of the power grid enterprises. In order to achieve the basic strategy of sustainable development, it is necessary to strengthen the fine management and enhance the control ability of the engineering investment cost. To achieve the goal, it is particularly important to systematically study the dynamic control technology of the power engineering costs, including the mining and correlation of cost influencing factor, the study of engineering cost prediction theory, popularization of comprehensive cost dynamic monitoring technique and the implementation and summary of the cost management program. With the economic risks from the market competition of the power project markets, the influence on the project cost management and revenues of power enterprises is growing in the theoretical framework of power engineering cost dynamic control system. Project cost management measures in the engineering cost theoretical research mainly focus on the upper management strategies from the macroscopic perspective, which are lack of the micro-studies on the engineering cost influencing factors; with the macro-management techniques, it is not enough to develop the control target of the fine costs in the actual operation and optimize the cost structure of the engineering projects.

### SUMMARY

The object of the invention is to overcome the above shortcomings and provide a management method of power engineering cost.

To achieve the above object, this invention adopts the following technical solutions:

1. collect and collate the cost data of historical power engineering and new engineering complete the pre-processing work of data cleansing and classification, and establish engineering sample database;
2. Explore the factors influencing power engineering cost, construct the cost factor associated topology according to the degree of correlation between factors, to form the core architecture of the model;
3. Screen the main factors that affect the engineering cost according to the factor associated topology, and identify the price transmission path;
4. Establish the cost change trend model that considers the cost time lag and its price transmission path based on the factor distribution on the price transmission path, and conduct training on the model combined with the data in the engineering sample database, solve the set of cost change trend of the equipments and materials required in the current stage of engineering.

The following describes the key steps of the control techniques for the cost factor topology and the cost change trend model of the price transmission path.

1. collect and collate the cost data of historical power engineering and new engineering complete the pre-processing work of data cleansing and classification, and establish engineering sample database;

Any data analysis is inseparable from complete and effective data base, therefore, in this invention, during building a price transmission dynamic management model of the overhead line engineering, it is required to complete the data collation firstly, including collection of the cost data of historical power engineering and new engineering at different stage, cleansing of the missing and unreasonable data, to achieve classification and consolidation of cost data. The objects of the engineering cost data collected and collated include price information, statistics of quantities, technical parameters and text-based data stored in the database in a form of file storage, such as laws and regulations on the survey and design, construction and land acquisition in different regions, etc. These data are classified according to the engineering type, unit works and engineering stage, with unified data unit, to separate related information field to establish limited engineering index.

The actual data collected from the different stages of the historical power engineering and new engineering are inevitably missing, uncertain, inconsistent and redundant, etc. If the model in the invention is directly applied to the untreated actual data, it will cause sharp increase in running space and time complexity and output unreasonable extraction rules and incorrect predictive results, therefore, it is necessary to pre-process these data, cleanse the missing and unreasonable data, and its judgment basis and processing way are shown in Table 1.

In the invention, through the pre-processing of unreasonable engineering cost data according to the judgment basis, it can achieve the purposes of eliminating historical data noises, fill up the missing cost data and revising the error cost data, so as to complete the historical engineering sample database of data cleansing and classification.

2. Explore the factors influencing power engineering cost, construct the cost factor associated topology according to the degree of correlation between factors, to form the core architecture of the model.

In order to clarify the relationship between the power engineering cost and price transmission, it is required to further explore the factors influencing the cost, construct the cost factor associated topology and identify the transmission path between factors. During exploring and analyzing the cost influencing factors, the model in the invention combines the quota standard of power engineering in the stage, to identify the engineering cost and if the engineering program is reasonable and economical, gives full consideration to the price-volume relationship that affects the cost composition, studies the feasibility of influencing factors, forming the model architecture of factor topology. The economical and reasonable principles in the invention is that, with the premise of ensuring the quality of power engineering and the combination of technology and economy in the construction process, effectively control the costs of power engineering in various life cycles, so that the actual investment of the power engineering in each stage fluctuates within a range of the estimated values in the previous stage, and the scope of fluctuation varies with the specific engineering, to ensure that the investors can achieve the best reasonable revenues from the power engineering within the specified period of use.

3. Screen the main factors that affect the engineering cost according to the factor associated topology, and identify the price transmission path.

It is not realistic to fully consider all factors and the combination of routes when exploring the price transmission association path that affects the cost. Therefore, it is required to perform association weight analysis on the complete factor topology model, and through the simplified theory, identify the main factors that affect the cost, to have a clear understanding of the price transmission path. The weight analysis includes the division of factor topology subnetwork according to classification dimension (such as voltage level, category of unit works), KMO test of any two correlation terms in the network, to calculate their correlation matrix of reflected image, judge if a factor is appropriate for factor analysis, and input the eligible factors to the principal component analysis model to solve the corresponding weight assessment scores. Through the results, screen the collection of factors that should be considered in price transmission association identification, to determine the price transmission path.

KMO (Kaiser-Meyer-Olkin) test statistic is an index to compare the simple correlation coefficient and partial correlation coefficient between variables. The KMO statistic is a value between 0 and 1. When the quadratic sum of all simple correlation coefficients between variables is far greater than the quadratic sum of partial correlation coefficients, the KMO value is close to 1. The closer to 1 the KMO value, the stronger the correlation between variables, and the original variables are more suitable for factor analysis; when the quadratic sum of all simple correlation coefficients between variables is close to 0, the KMO value is close to 0. The closer the KMO value to 0, the correlation between variables is weaker, and the original variables are more unsuitable for factor analysis. Kaiser gives a common KMO measurement level as follows: 0.9 or above: very suitable; 0.8: suitable; 0.7: ordinary; 0.6: not suitable; 0.5 or less: extremely unsuitable.

4. Establish the cost change trend model that considers the cost time lag and its price transmission path based on the factor distribution on the price transmission path, and solve the set of cost change trend of the equipments and materials required in the current stage of engineering.

The most core part of power engineering cost dynamic management and control system is the price transmission model. The invention mainly focuses on the price involved in the engineering and its potential correlation. The power engineering construction requires the purchase of equipments, and installation materials. In market economy conditions, the transaction prices of the above equipments and installation materials will fluctuate with the influence of multiple factors, and influence the purchase prices of them along the price transmission path. The manufacturing system has the path that influences products and various raw materials required for manufacturing the products, and these paths have coupling correlations, therefore, fluctuations of prices of one or more kinds of raw materials will comprehensively influence the prices of the downstream products through these paths. It will not only influence the product price integration by the market, but also influence the vertical price transmission part of equipments and installation materials along the manufacturing industry chain from the upstream to the midstream and downstream. Therefore, when identifying the inherent price transmission characteristics of the power engineering cost, it should reflect the leverage effect of prices in the industry chain transmission process, but also combine the mutual interaction on the prices of equipments and installation materials on different transaction markets and the cost transmission process from the upstream and midstream to the downstream of the manufacturing industry chain. With such a price transmission correlation chain, the production and sales of these equipment and installation materials have a time lag, in addition, the government department will implement appropriate intervention and control on the prices of equipments and installation materials according to the price fluctuations of raw materials, thus, it is possible to have price lag and divergence when the price fluctuations of raw materials are transmitted to the equipments and installation materials. When building price transmission model, full considerations should be given to the reaction period of the equipments and installation materials during the production and the government's control over price of them included in the power engineering. In the invention, the establishment of the cost factor topology and the cost change trend model of the price transmission path include the following sub-steps:

### (1) Establish the Price Timing Regression Model

According to the analysis on the transmission correlation between the price series, the statistical significance of price transmission path will be considered gradually in theory. It is believed that, if the historical sequence of factor A {A|a_{i,j}εA, i=1 . . . m, j=1 . . . N} can help to explain the cost b_{N} of equipments or materials required for the works in the (N+1)-th year or quarter or month, then there is a precedence relationship and casual relationship between A and B. The selection of year/quarter/month is determined by the data precision. In the following, the descriptions are based on quarter. In order to timely and accurately capture the features of fluctuation of material price, break through the limitation of the static cost management and investigate the interaction mechanism between series dynamically, the price timing implicit function model is established:

b_{N}=f(a_{1,1}, . . . ,a_{1,N},a_{2,1}, . . . ,a_{2,N}, . . . ,a_{m,1}, . . . ,a_{m,N},b₁, . . . ,b_{N-1}) (1)

### (2) Adjust the Lag Transmission Order of Price Transmission Sequence

Statistical analysis of the factors A₁˜Aₘ and the price trend of the cost B, and summarization of the price fluctuation transmission cycle. For the price fluctuation forecasting, the factor values in the transmission cycle are selected for accurate expression. The approximate integer of average transmission cycle iₘₐₓ is taken and the iₘₐₓ is chosen as the lag transmission order, to reduce dimension of the model sequence, as follows:

b_{N}=f(a_{1,N-imax}, . . . ,a_{1,N},a_{2,N-imax}, . . . ,a_{2,N}, . . . ,a_{m,N-imax}, . . . ,a_{m,N},b_{N-imax}, . . . ,b_{N-1}) (2).

(3) Train Price Transmission Model with RBF Neural Network

The RBF feedforward neural network is constructed. The topology includes three-layer nodes, as shown in FIG. 3. The network is a single output (cost B), the hidden layer of the three-layer feedforward structural network has a group of unit nodes, and transfers the transmission correlation of factors A₁˜Aₘ and historical engineering cost B through the nonlinear function mapping relationship, of which, the nonlinear function mapping relationship between the hidden layer and input layer, output layer is expressed as the formula (3):

$${f}_{R} ( u ) = {\sum }_{i = 1}^{p} {ω}_{i} G ( ‖ u - {c}_{i} ‖ , {σ}_{i} ) \qquad ( 3 )$$

Where, p represents the number of nodes of the hidden layer, ωᵢ represents the weighted value of the i-th node and the output node of the hidden layer, cᵢ represents the median value of nodes in the hidden layer, σᵢ represents the normalized parameters, G(Λ) represents the functional form of expression of the step function of the hidden layer; in the model, Λ selects the noun of the difference between the input value and the node of the hidden layer and normalized parameter σᵢ as input. The step function selected herein is a Gauss function. RBF neural networks: RBFNN is a kind of three-layer feedforward neural network, which is often used for parameter estimation of implicit function model, training the historical data samples, with the features of fast learning convergence speed and strong nonlinear approximation ability, etc.

(4) Output the transmission result B_{N+1} of price fluctuation of the (N+1)-th quarter against the cost B, which is used as a reference for the compilation of engineering cost budget in the stage.

Firstly, the latest price data of cost influencing factors A₁˜Aₘ of the (N+1)-th quarter collected are denoted by {A_{i,N=1}|i=1 . . . m}; then the sequence data and the historical sequence data of iₘₐₓ length are input to the highly trained cost change trend model, to solve the cost prediction value b_{N+1} of equipments or materials required for the engineering of (N+1)-th quarter.

(5) Repeat the sub-steps (1)-(4) for unit costs of different equipments and materials for power engineering, to form the unit cost trend sequence B_{N+1} of all equipments and materials of the (N+1)-th quarter. Use the results in the actual engineering budget compilation of the (N+1)-th quarter, and fluctuate the prices of equipments and materials on the basis of engineering quota, to further restrict the compilation of the spread on costs, and incorporate the dynamic measurement of the cost change trend model against the price timing in the invention, so as to provide auxiliary support for decision-making for determining the meticulous management objective of the power engineering cost with high precision, fast speed and timeliness.

The beneficial effect of the invention is to establish a cost change trend model involved with cost factor topology and its price transmission path. Numerical results show that, this invention can be used in the management of power engineering cost in the power grid enterprises; by considering the effect of market price fluctuation on the price transmission of required equipments and materials, and dynamically establishing the control objective of the engineering cost, this invention can propose appropriate management control program for the next stage of engineering costs more clearly, further shrink the deviation of cost, reduce the investment risk of power engineering and improve the dynamic control system of power engineering.

### BRIEF DESCRIPTION OF THE DRAWINGS

FIG. 1 shows a flow chart of a management method of power engineering cost provided in the present invention;

FIG. 2 shows a historical price trend and transmission analysis chart of factors X, Y and cost Z provided in the present invention;

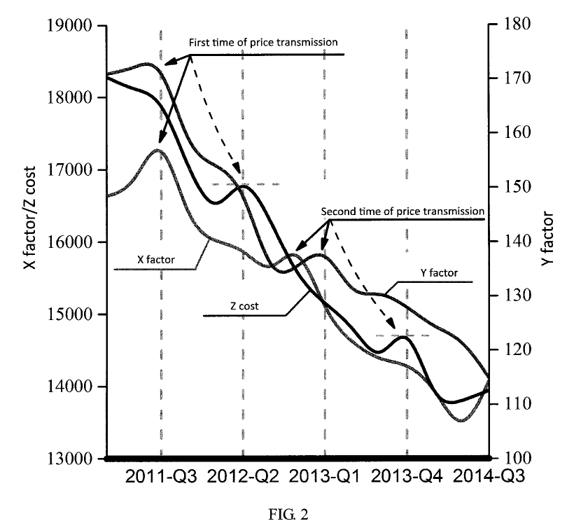

FIG. 3 shows a three-layer RBF network model of price transmission model provided in the present invention;

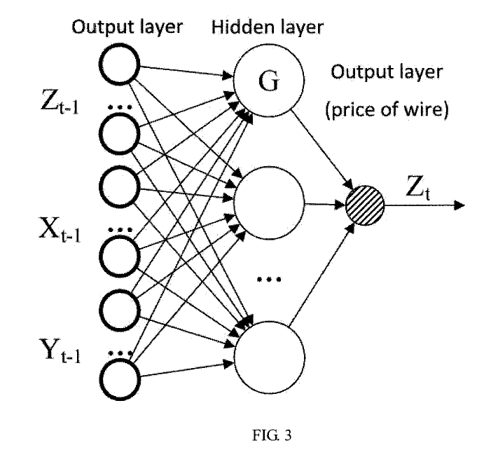

FIG. 4 shows a cost factor associated topology of overhead line engineering provided in the present invention;

### DETAILED DESCRIPTION

Table 1 shows a pre-processing judgment basis and processing mode of power engineering cost;

TABLE 1

| Judgment Basis | Treatment Measures |
|---|---|
| Inconsistent data format | Unified data formats, |
| | including data unit, counting |
| | mode, text formatting, etc. |
| Data-level logical inconsistency | Inconsistent data transformed |
| | to correct level |
| Consistent repeated data for the same | Delete duplicated data |
| level | |
| Engineering cost data missing, but can | Deduct according to the data |
| be derived from the adjacent data list | within or between levels |
| Over half of data are missing in the | Delete statistical samples of |
| engineering cost table, but unable to | engineering costs |
| deduct from the known data | |
| Obvious difference between unit price | Recheck the fixed quota of the |
| and other engineering | engineering cost, correct or |
| | delete data |
| Inconsistency between the summary | Re-deduct according to the |
| data within the level and total price | cost data within the level |
| of levels | |
| Maximum or minimum singular points | Correct the cost data according |
| existing in the cost data | to the unit cost and quantity |

Table 2 shows a result analysis of ACSR LGJ-300/25 wire price transmission;

TABLE 2
unit: 10,000 yuan

| | | | Steel index fluctuation | | | | |
|---|---|---|---|---|---|---|---|
| | | | −10% | −5% | 0% | +5% | +10% |
| Wire price transmission result | | | 103.34 | 109.08 | 114.82 | 120.56 | 126.30 |
| Aluminum | −10% | 12668 | 13411 | 13430 | 13452 | 13477 | 13504 |
| material | −5% | 13371 | 13550 | 13586 | 13627 | 13673 | 13723 |
| price | 0% | 14075 | 13805 | 13869 | 13940 | 14018 | 14102 |
| fluctuation | +5% | 14779 | 14234 | 14336 | 14444 | 14560 | 14681 |
| | +10% | 15483 | 14864 | 14998 | 15136 | 15276 | 15418 |

Table 3 shows a comparison of 220 kV overhead line construction cost data;

TABLE 3
Unit: 10,000 yuan, ton, 10,000yuan/ton

| | | Overhead engineering cost | | Cost of wire materials | | |
|---|---|---|---|---|---|---|
| | Total | Installation | Of which, cost of | Total cost of | Quantity of | Unit price of |
| | engineering | engineering | installation | wire | wire | wire |
| | cost | cost | materials | materials | materials | materials |
| Budget | 3394.80 | 844.76 | 533.10 | 481.60 | 286.66 | 1.680 |
| estimate | | | | | | |
| Billing | 2873.40 | 752.08 | 441.55 | 400.82 | 287.70 | 1.393 |
| Savings | 15.36% | 10.97% | 17.17% | | | |
| rate | | | | | | |
| Corrected | 3324.28 | 774.24 | 462.58 | 411.08 | 286.66 | 1.434 |
| estimates | | | | | | |
| Corrected | 13.56% | 2.86% | 4.55% | | | |
| savings | | | | | | |
| rate | | | | | | |

Table 4 shows a list of influencing factors of overhead line engineering cost.

TABLE 4

| Cost factor | Quantity factor | Price factor | Other factor |
|---|---|---|---|
| Site stretching | Line length | Unit price of wire | Number of wire |
| construction | | | splits |
| price | | | |
| Wire material | Quantity of | domestic spot | Number of loops |
| cost | wires | price of steel/ | |
| | | aluminum material | |
| Wire erection | Quantity of | Domestic futures | Ratio of terrain |
| fee | stretching sites | price of steel/ | |
| | | aluminum material | |
| Materials | Number of | | Characteristics |
| transport | crossing | | and type of |
| price | | | crossed objects |
| Cross-erection | | | Line length |
| fee | | | |
| | | | Wire material |
| | | | Area of single |
| | | | wire |
| | | | Number of wire |
| | | | cores |
| | | | Voltage level |

The present invention is further described in details in combination with the drawings and specific embodiments.

In the invention, by combining with the factor mining theory, identifying the factors influencing power engineering cost, a correlation topology between factors is established and a management method for dynamic power engineering cost incorporating the price transmission path and factor fluctuation is proposed. Through building the price transmission dynamic management model, it focuses on analysis of quantification transmission degree of price fluctuations of equipment and materials at the stage on the engineering cost, and perform testing on the model validity by selecting actual engineering data, so as to provide decision support of market factors for better developing the objectives of dynamic cost management.

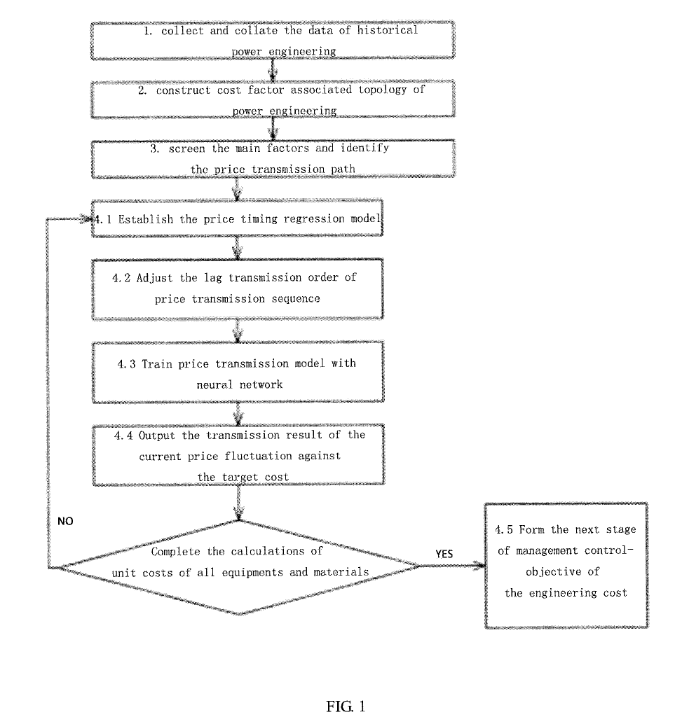

Referring to FIG. 1, a management method of power engineering cost incorporating price transmission path and factor fluctuations, including the following steps:

1. collect and collate the cost data of historical power engineering and new engineering complete the pre-processing work of data cleansing and classification, and establish engineering sample database.
2. Explore the factors influencing power engineering cost, construct the cost factor associated topology according to the degree of correlation between factors, to form the core architecture of the model.
3. Screen the main factors that affect the engineering cost according to the factor associated topology, and identify the price transmission path.
4. Establish the cost change trend model that considers the cost time lag and its price transmission path based on the factor distribution on the price transmission path, and conduct training on the model combined with the data in the engineering sample database, solve the set of cost change trend of the equipments and materials required in the current stage of engineering.

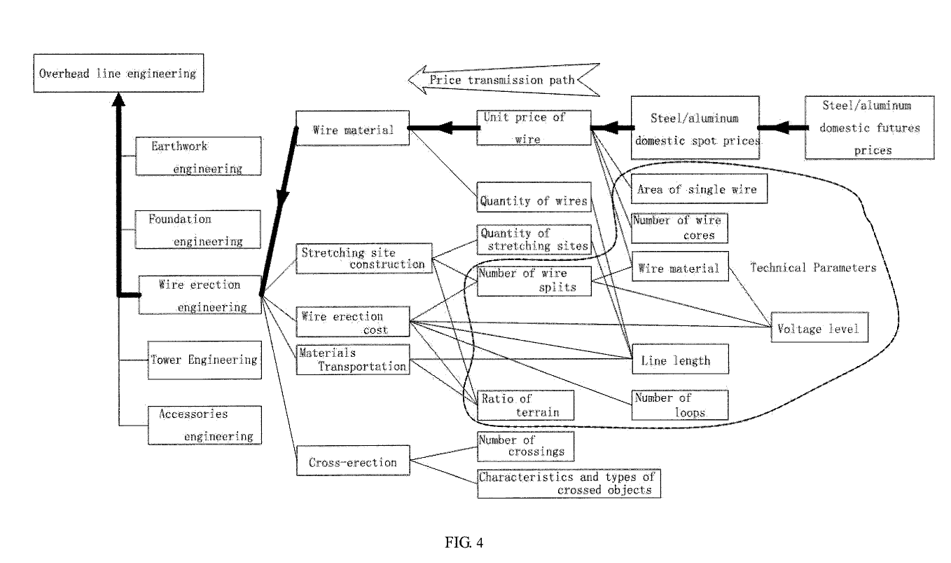

Taking the prediction of overhead line engineering cost as an example, through exploring the cost factor influencing path, the correlation topology between factors is formed and the factor path of the overload line engineering is selected as shown in FIG. 4. By further consolidation on the cost influencing factor of the overhead line engineering, the cost of the wire materials is mainly decided by the unit price and quantity of wires; while the unit price is directly associated with the market price fluctuation, therefore, the unit price of wire is selected as a research object of the numerical example model in the invention.

The wire information price is adopted for the conductor wires which reflect the reference price of the building materials issued by the construction cost management department to the public regularly through a comprehensive analysis of market research and embodies the price fluctuations of this model of wires. The aluminum price adopts the Shanghai aluminum futures price in the stage issued by Shanghai Futures Exchange; while the fluctuation of the steel prices adopt the composite steel price index released by the steel market, which reflects the changes of the prices of raw materials purchased by the production enterprises and the overall price change in the markets. For the above data, the price of wire is from the internal industry data, the price of aluminum is from the monthly contract closing data of futures in the Shanghai Futures Exchange, the steel composite index is from MyspiC. All data used are the quarterly data from first quarter of 2011 to the third quarter of 2014.

The above data are input in the training model, and data samples of the price transmission path for the unit prices of wires in the overhead line engineering were simulated for training using related software. The specific model parameter calculation and solution process are as follows:
(1) select lag transmission order imax as 3, collect the original input and output data of the wire unit prices for the overhead line engineering, to obtain 15 groups of sample data, forming a sample independent variable matrix [A_{1,N}, A_{2,N}, B_{N-1}] (15×11) and a sample dependent variable matrix [B_{N}](15×1), of which the sample independent variable matrix [A_{1,N}, A_{2,N}, B_{N-1}] is denoted as [X]. The sample data are divided into two parts: one part is used as training samples (12 samples) for establishing the RBF neural network-based price timing regression model, and the other part is used for testing the generalization ability of samples used to evaluate the RBF Neural Network.
(2) The normalization process. the original data [X] and [B_{N}] are normalized according to the formula (4) and the sample data are scaled to the scope of [−1, 1].

$$x = \frac{max ( x ) - x}{max ( x ) - min ( x )} + 1 \qquad ( 4 )$$

(3) Establish primitive RBF neural network, and take all input variables as the parameter cᵢ of the central point of the hidden layer. By setting the width value of the original correlation center, calculate the hidden layer output matrix \hat{B}² using the Gaussian kernel function, when the Gaussian function is used as a basis function, the output response of the i-th hidden node can be expressed as the formula (5),

$${B}_{i}^{2} ( {x}_{j} ) = exp ( - \frac{{‖ {x}_{j} - {c}_{i} ‖}^{2}}{2 {σ}_{i}^{2}} ) , j = 1 … 12 \qquad ( 5 )$$

Where, ∥xⱼ−cᵢ∥ is an euclidean distance from xₖ to cᵢ.
(4) The output matrix of the output layer \hat{B}³. The output of output layer of RBF neural network is expressed as formula (6):

$${B}_{k}^{3} ( {x}_{j} ) = {\sum }_{i = 1}^{12} {w}_{ik} {B}_{i}^{2} ( {x}_{j} ) + {c}_{k} \qquad ( 6 )$$

Where, the result of Bₖ³(xⱼ) in the table above is the output value of RBF neural network output layer, the weight of the i-th neuron in the hidden layer and the k-th neuron of the output layer is represented by wᵢₖ, while the constant value of the k-th neuron in the output layer is represented by cₖ.
(5) Calculate the RBF neural network output value B³ according to formula (6) and formula (7), and through continuous iteration with the original output value B used in the correlation training samples, calculate the weight coefficient between the hidden layer and output layer, and the training process is completed until the standard function value is less than a threshold.
(6) after the original neural network computing all parameters determined using a test sample substituted into the neural network model and solve the corresponding B3 value, (7) the final prediction error is calculated using the formula neural network to assess the generalization ability of the network,
(6) After all parameters of original neural network are determined, substitute the test samples into the neural network model and solve the corresponding B³ value, calculate the final prediction error of the neural network according to formula (7), so as to assess the generalization ability of the network,

$$MSE = \frac{1}{q} {\sum }_{i = 1}^{q} {\sum }_{j = 1}^{12} {( {B}_{ij}^{3} - {B}_{ij} )}^{2} \qquad ( 7 )$$

Where, q is the number of test samples, and it is 3 in the numerical examples in the invention.

The example results in the invention show that, the proposed model can further design the aluminum material price fluctuation and the fluctuation of steel index. Perform transmission analysis on the wire price under different scenarios (such as 0%, ±5%, ±10%), input different fluctuations of aluminum prices and steel index into the final RBF neural network model, and through the calculation of weight parameters, the price of wire corresponding to the fluctuation degree is obtained, to reflect the changes of unit price of wires under the above two factors, as shown in Table 2 and Table 3. This method can be effectively applied to the management process of the engineering cost of the power grid enterprises, and through comprehensive consideration to the influence of the market price fluctuation on the costs, the price transmission effect of the equipments and materials in the stage of engineering can be analyzed, and the appropriate cost control objectives can be worked out, to propose appropriate management control program for the next stage of engineering costs more clearly, further shrink the deviation of cost, reduce the investment risk of power engineering and improve the dynamic control system of power engineering.

The cost factor association topological model constructed in the invention according to the degree of correlation between factors complies with the specification for costs for power transmission and transformation engineering, divides the quantity factor and price factor of each unit work, further separates the human, material and machine factors for the engineering cost, to limit the hierarchy of each influencing factor, collate and analyze the cost data items and technical and economical parameters of different types of power engineering in various stages, and gradually sort out the power engineering cost factor associated topology according to the corresponding hierarchical structure, and finally adjust them in combination with the relationship between the expert discussion results and various cost factors in the topology. Taking the overhead line engineering as an example, as shown in FIG. 4, specific steps are as follows:

The Specification for Power Transmission and Transformation Costs specifies that the overhead engineering cost mainly consists five parts: site stretching construction price, conductor wire material price, wire erection price, materials transport price and cross-erection price; taking the wire material price as an example, the price is a weighted statistic data of the unit price (price factor) and quantity of wire materials (quantity factor); the unit price of each wire is mainly determined by the area of single wire, number of wire cores, wire materials and domestic spot price of steel/aluminum material. The cost influencing factors of other sub-costs can be derived according to the above steps. After investigating the influencing factors of the five costs that consist of the overhead line engineering cost, the list of influencing factors of the overhead line engineering cost is obtained as shown in Table 4. Next, in the association network topology visualization model, the levels of influencing factors are gradually clear from left to the right, and there are three kinds of association relationship among factors: cumulative relationship, geometric relationship, and attribute influence relationship. It is specifically described as follows: the wire material price includes the unit price and the quantity of wire, and the unit price is mainly decided by the domestic spot prices of steel/aluminum material and the model of wires. The determination of wire model includes wire material, area of single wire and number of cores of wire, etc.; the cost of site stretching construction is affected by the number of stretching sites, number of splits of wires and the terrain. The more the stretching sites, the cost for the stretching site construction rises at equal ratio, and the number of spits of wire and the terrain mainly determine the form of stretching site construction; the unit price factor for the installation of wire erection is jointly influenced by the voltage level, number of loops, the number of wires split, the ratio of terrain. The quantity factor of erection is determined by the length of line; in addition, the cross-erection price is influenced by the type and characteristics of objects crossed. The more the crossings, the cost for cross-erection rise at equal ratio; and through the above steps, the overhead line engineering cost factor associated topology is finally obtained as shown in FIG. 4.

The specific embodiments described above, as preferred embodiments, are used to explain the present invention rather than limit the invention. Any modification, equivalent replacement and improvement made within the spirit and claims of the invention shall fall within the scope of protection of the present invention.

1. A management method of power engineering cost, comprising the following steps:
(1) collect and collate the cost data of historical power engineering and new engineering at different stage, cleanse missing and unreasonable data, to achieve classification and consolidation of cost data, complete the pre-processing work of data cleansing and classification, and establish engineering sample database;
(2) Conduct analysis on factors influencing power engineering cost and construct cost factor associated topological model according to the degree of correlation between factors based on the principle of economical and reasonable engineering cost and engineering program;
(3) Perform weight analysis on the cost factors in the cost factor associated topological model, and screen the collection of factors that should be considered in price transmission association identification through the size of weights, to determine the price transmission path;
(4) Establish the cost change trend model that considers the cost factor topology and its price transmission path based on the factor distribution on the price transmission path, and conduct training on the cost change trend model combined with the data in the engineering sample database, solve the set of cost change trend of the equipments and materials required in the current stage of engineering, and the cost change trend model is a price timing implicit function model based on historical values of factors and engineering costs.

2. The management method of power engineering cost according to claim 1, wherein the project cost data in step (1) include price information, statistics of quantities, technical parameters and text-based data stored in the database in a form of file storage.

3. The management method of power engineering cost according to claim 1, wherein the engineering cost data collected in step (1) are classified according to the engineering type, unit works and engineering stage, with unified data unit, to separate related information field to establish limited engineering index.

4. The management method of power engineering cost according to claim 1, wherein the weight analysis in step (3) include division of factor topology subnetwork according to classification dimension, KMO test of any two correlation terms in the network, to calculate their correlation matrix of reflected image, judge if a factor is appropriate for factor analysis, and input the eligible factors to the principal component analysis model to solve the corresponding weight assessment scores.

5. The management method of power engineering cost according to claim 1, wherein the cost change trend model in the step (4) includes a price timing regression model, and the price timing regression model is expressed as follows:
b_{N}=f(a_{1,1}, . . . ,a_{1,N},a_{2,1}, . . . ,a_{2,N}, . . . ,a_{m,1}, . . . ,a_{m,N},b₁, . . . ,b_{N-1})
where, N represents the number of years or quarters or months of the collected cost data, b_{N} represents the costs of the equipment or materials for the engineering in the N-th year, or quarter or month, the price timing regression model considers m cost influencing factors, where ≧2, a_{i,j} represents the value of the i-th cost influencing factor Aᵢ in the j-th year, or quarter or month.

6. The management method of power engineering cost according to claim 5, wherein it concludes the price fluctuation transmission cycle based on price timing regression model, statistical analysis factor A₁˜Aₘ and the trend of cost B, takes the approximate integer of average transmission cycle iₘₐₓ, and selects the iₘₐₓ as the lag transmission order, to reduce dimension of the model sequence, as follows:
b_{N}=f(a_{1,N-imax}, . . . ,a_{1,N},a_{2,N-imax}, . . . ,a_{2,N}, . . . ,a_{m,N-imax}, . . . ,a_{m,N},b_{N-imax}, . . . ,b_{N-1}).

7. The management method of power engineering cost according to claim 6, wherein RBF feedforward neural network is used to train the cost change trend model, and the topological structure of RBF feedforward neural network comprises three-layer nodes, the hidden layer of the three-layer feedforward structural network has a group of unit nodes, and transfers the transmission correlation of factors A₁˜Aₘ and historical engineering cost B through the nonlinear function mapping relationship between the hidden layer, input layer and output layer.

8. The management method of power engineering cost according to claim 7, wherein the nonlinear function mapping relationship between the hidden layer, input layer and output layer is represented as follows:
$${f}_{R} ( u ) = {\sum }_{i = 1}^{p} {ω}_{i} G ( ‖ u - {c}_{i} ‖ , {σ}_{i} )$$
Where, p represents the number of nodes of the hidden layer, ωᵢ represents the weighted value of the i-th node and the output node of the hidden layer, cᵢ represents the median value of nodes in the hidden layer, σᵢ represents the normalized parameters, G(Λ) represents the step function of the hidden layer, where Λ selects the norm of the distance between the input value and the node of the hidden layer and normalized parameter σᵢ as input.

9. The management method of power engineering cost according to claim 8, wherein the step function of the hidden layer selects a Gauss step function.

10. The management method of power engineering cost according to claim 7, wherein the latest price data of cost influencing factors A₁˜Aₘ of the (N+1)-th year or quarter or month collected are denoted by {A_{i,N+1}|i=1 . . . m}; then the sequence data and the historical sequence data of iₘₐₓ length are input to the highly trained cost change trend model, to solve the cost prediction value b_{N+1} of equipments or materials required for the engineering of (N+1)-th year or quarter or month.

11. The management method of power engineering cost according to claim 8, wherein the latest price data of cost influencing factors A₁˜Aₘ of the (N+1)-th year or quarter or month collected are denoted by {A_{i,N+1}|i=1 . . . m}; then the sequence data and the historical sequence data of iₘₐₓ length are input to the highly trained cost change trend model, to solve the cost prediction value b_{N+1} of equipments or materials required for the engineering of (N+1)-th year or quarter or month.

12. The management method of power engineering cost according to claim 9, wherein the latest price data of cost influencing factors A₁˜Aₘ of the (N+1)-th year or quarter or month collected are denoted by {A_{i,N+1}|i=1 . . . m}; then the sequence data and the historical sequence data of iₘₐₓ length are input to the highly trained cost change trend model, to solve the cost prediction value b_{N+1} of equipments or materials required for the engineering of (N+1)-th year or quarter or month.
